(19) United States
(12) Patent Application Publication
(10) Pub. No.: US 2013/0319169 A1
(43) Pub. Date: Dec. 5, 2013

(54) BICYCLE STEM HAVING CONTROLLED RELEASE OF THE STEERABILITY THEREOF

(71) Applicant: Franck Jean Savard, Saint-Martin-de-Re (FR)

(72) Inventor: Franck Jean Savard, Saint-Martin-de-Re (FR)

(73) Assignee: SAGA BIKE, Saint-Martin-de-Re (FR)

(21) Appl. No.: 13/983,800

(22) PCT Filed: Jan. 6, 2012
(86) PCT No.: PCT/FR2012/050039

§ 371 Date: Aug. 6, 2013

(30) Foreign Application Priority Data
Jan. 6, 2011 (FR) 11 0039

(51) Int. Cl. B62K 21/18

(52) U.S. Cl. CPC B62K 21/18
USPC 74/551.8

(57) ABSTRACT

A stem (10) for a bicycle handlebar having controlled release of the steerability thereof, includes a body (24) intended for receiving a stem arm (12) which in turn receives a handlebar, the stem also including a headset (40), elements (14) for attaching the stem (10) to the fork (16) of a bicycle including a head tube and a locking/unlocking element (18), wherein the locking/unlocking element (18) includes at least one key (56) placed in a cavity (54) arranged in the headset (40), a resilient element (58) for returning the at least one key towards the outside of the cavity, holes (36) arranged in the stem body (24) through which the keys pass, a ring (62) suitable for retracting the at least one key (56) through the holes (36) by a rotation or translation movement, respectively. The mounting also provides a headset arrangement.

This invention relates to a stem for a set of bicycle handlebars with controlled release of its steerability.

In front, a bicycle comprises a common arrangement comprising a fork, a steering socket that is integral with the bicycle frame with bearings, a stem that is integral with the fork, and a set of handlebars or handlebars that are integral with the stem and that can be maneuvered by the user.

There are two mountings of the fork in the steering support:
A so-called standard mounting primarily reserved for so-called urban bicycles or VTC (hybrid bicycles): This mounting comprises a fork with a tube that passes through the socket, with said tube accommodating a mast that is integral with the stem that comprises means for locking said mast in said tube, with these locking means for the most part being a beveled core maneuvered by a traction screw mounted in free form in said stem. Thus, the mast is inserted into the tube, and it is tightened, which has the effect of making said mast integral with said tube. The user can then maneuver the set of handlebars and the fork supporting the wheel, which thus has become integral in translation and in rotation.
A so-called ahead-set mounting, more especially reserved for VTT (all-terrain bicycles): This mounting consists in inserting into the fork tube a wedge in the form of a thick washer that is crenellated or shaped like “pine branches” and that works either directly with the inside wall of the fork tube or with grooves made in the fork tube although this washer is immobilized in rotation. This washer is thus immobilized in translation and in rotation.

The object of the stem according to this invention is to meet a double objective, that of allowing the bicycle to be stored and to perform an anti-theft function.

For storage, it is known that either in a parking space or in a residence, or even in a storage site or on transport means that are mounted on a car, for example, the handlebars generate a large space requirement unrelated to the very limited width of a bicycle.

Actually, it would be advantageous to be able to make the handlebars pivot for positioning them in the plane of the frame of the bicycle, which would greatly limit the space requirement.

In addition, it is also known that if the handlebars are left loose relative to the fork or if the handlebars are locked in this configuration, the bicycle cannot be used except to make mechanical modifications in a workshop. These handlebars that are loose or locked in the coplanar configuration can thus constitute a completely adequate anti-theft arrangement.

Numerous patents have proposed solutions for reaching such results.

In particular, the French patents FR 2 874 366 and FR 2 948 089 are known that propose arrangements that have developed in this direction that are automatic with manual unlocking and automatic fitting.

It is found that if these devices meet the fundamental principles, they allow, for the arrangement that is described in the first patent application FR 2 874 366, a certain play between the locking means and the set of handlebars, which makes the riding a little unstable and gives the user a feeling of insecurity, which is unsatisfactory.

In the case of the second application FR 2 948 089, the arrangement also requires very high precision in the manufacturing for limiting play but if the pieces are to be able to be installed easily, it is necessary to allow play, and the same discrepancies as above result, with the solutions being antinomic.

The object of this invention is to propose an arrangement that responds to the same problems as above but in which the play is compensated and that is totally integrated in the stem.

The device according to this invention covers the two types of mounting called standard and ahead-set.

The invention is now described in detail according to a particular, non-limiting embodiment, relative to the accompanying drawings in which the different figures show:

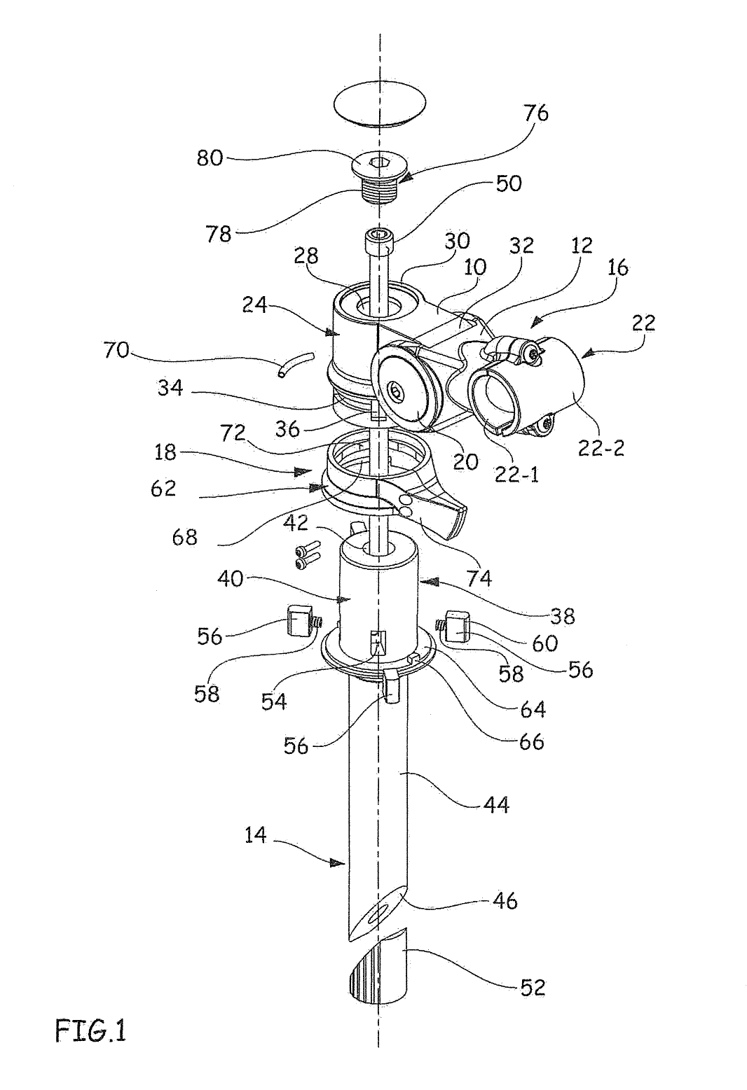

FIG. 1: An exploded perspective view of a stem according to this invention, in a standard mounting with a mast for locking by wedge on the fork,

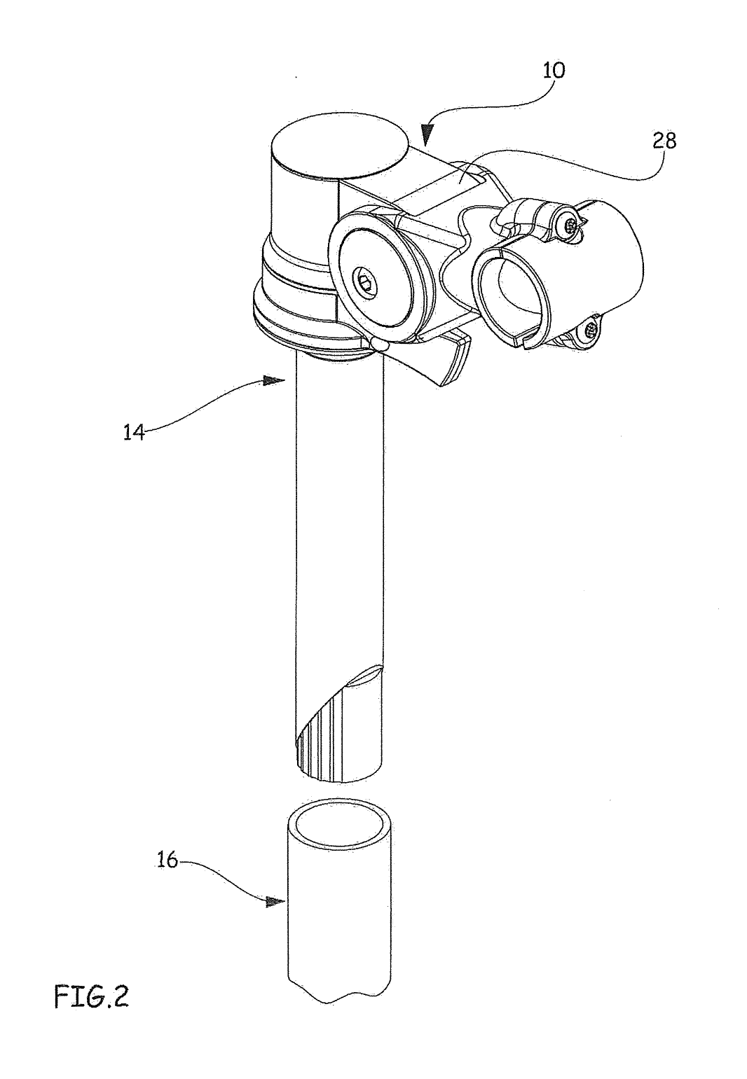

FIG. 2: A mounted view of the stem of FIG. 1,

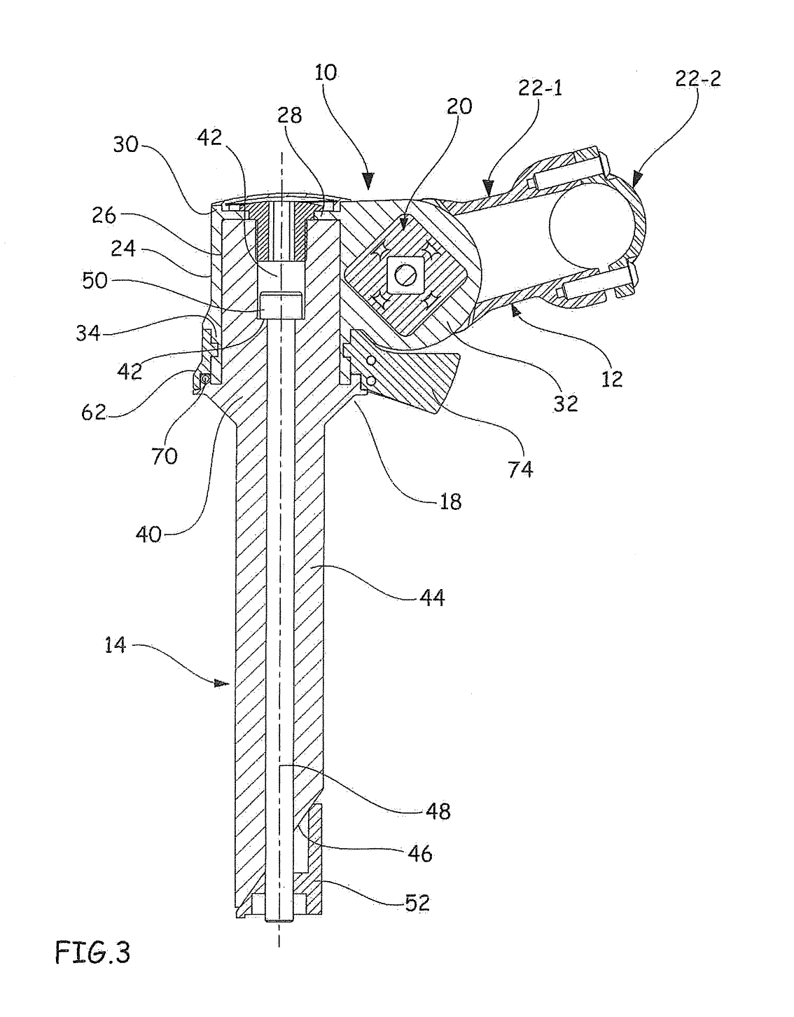

FIG. 3: A longitudinal cutaway view of the stem of FIG. 1,

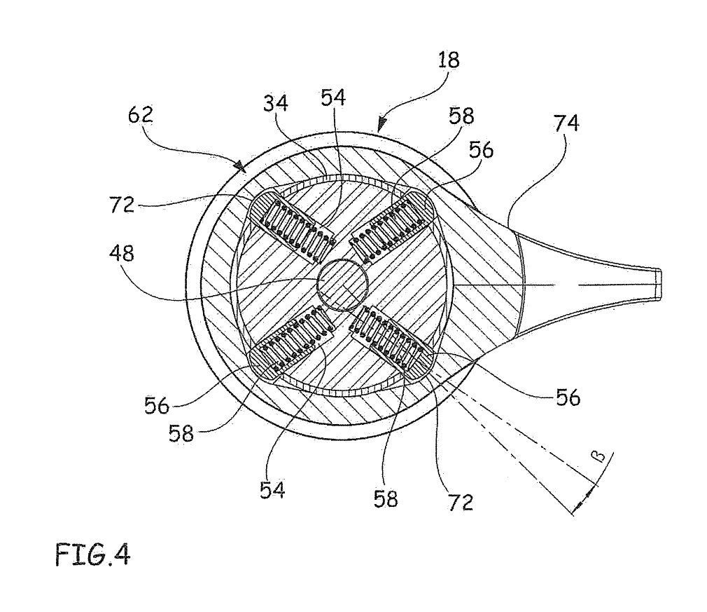

FIG. 4: A transversal cutaway view facing locking/unlocking means,

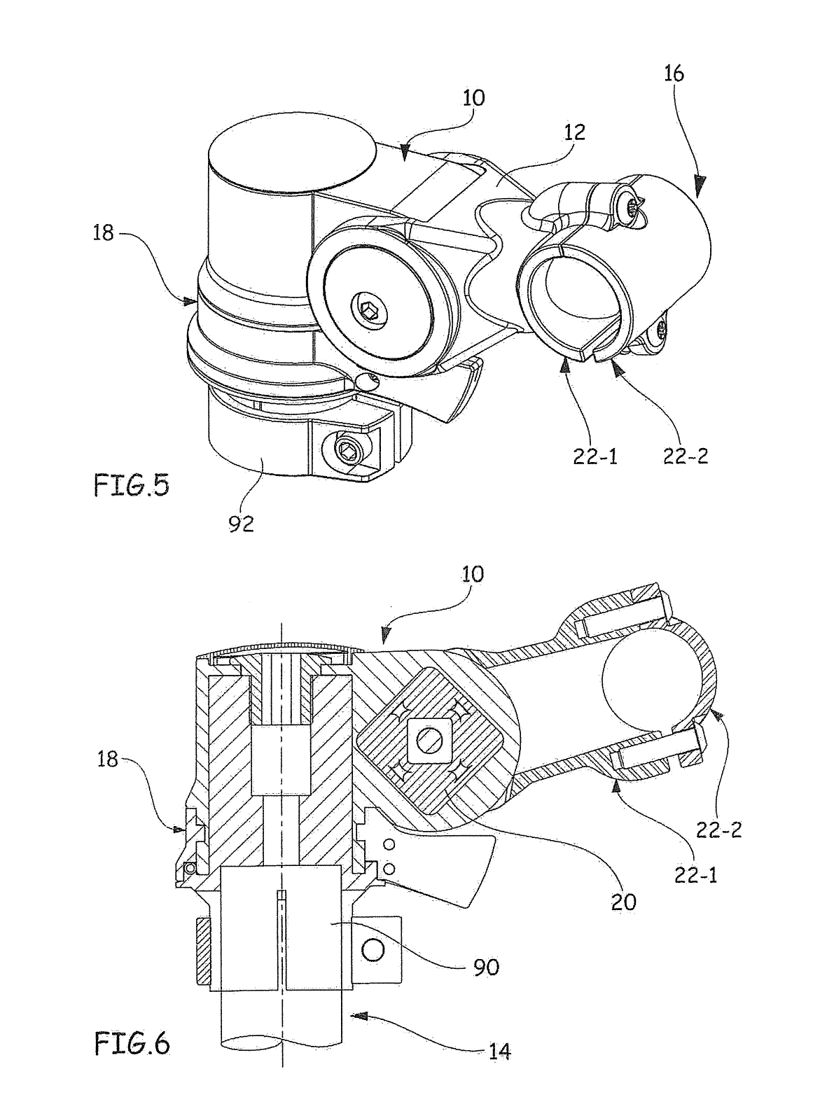

FIG. 5: A view of a variant of the attachment means of the stem according to this invention on the fork,

FIG. 6: A cutaway view of the variant of the attachment means of the stem of FIG. 5,

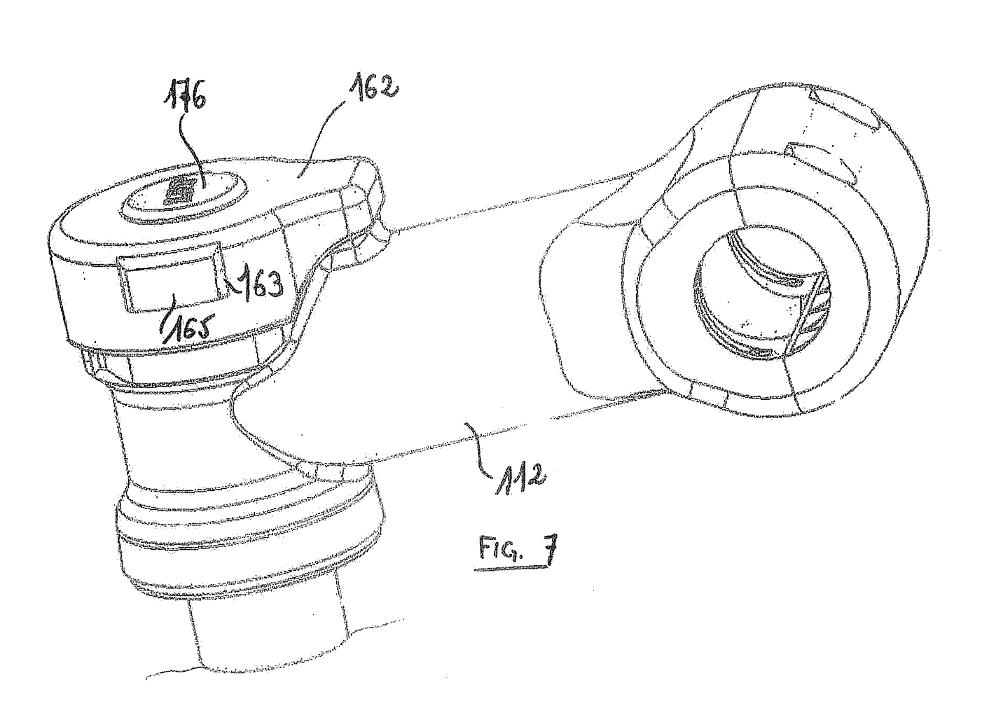

FIG. 7: An assembled view of the mounting of a stem according to this invention, in a so-called ahead-set mounting on the fork,

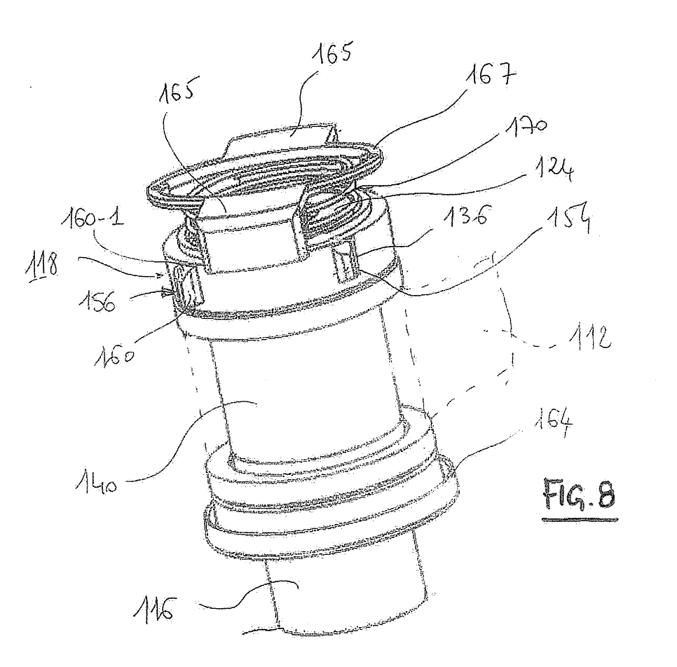

FIG. 8: A partially exploded view of the stem of FIG. 7 with the stem arm in broken lines,

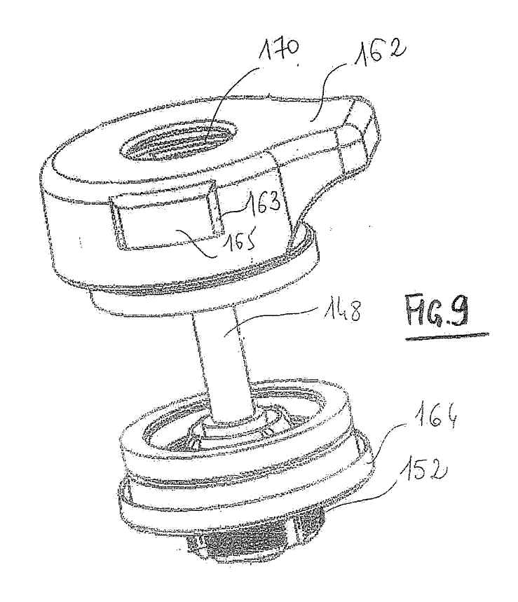

FIG. 9: An exploded view with the hood in place and the head-set removed,

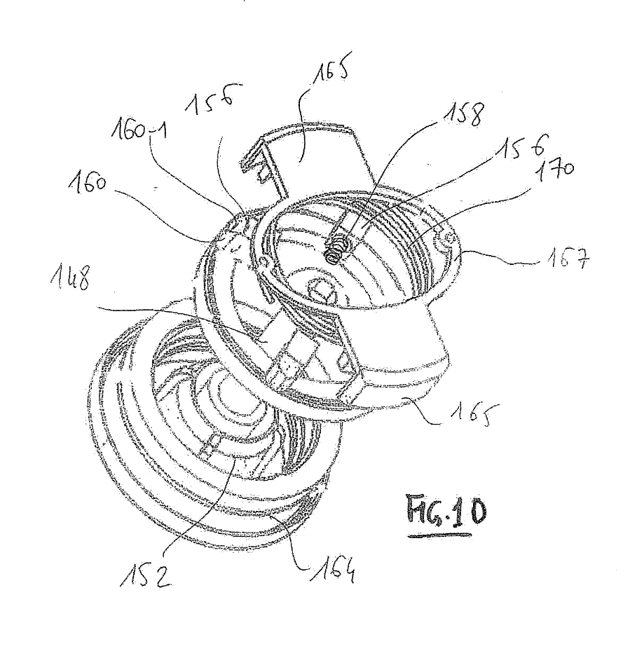

FIG. 10: An exploded perspective view making the keys appear.

FIG. 1 shows a stem with a standard mounting that comprises a stem 10, a stem arm 12 designed to accommodate a set of handlebars (not shown), and means 14 for attaching the stem 10 on the fork tube 16 with integrated locking/unlocking means 18.

Reference is made interchangeably to FIGS. 1-4 for the detailed description that follows.

The stem arm 12 is equipped at its distal end with means 22 for attaching a set of handlebars with two half-shells 22-1, 22-2 in a known way.

In the arrangement shown, slope and damping adjustment means 20 are provided at the proximal end of said arm, and said means have not been described in detail because they are commercially available.

The stem 10 comprises a stem body 24 that forms a socket with a blind inside cylindrical housing 26. This cylindrical housing 26 is provided with a hole 28 in its upper part. Likewise, a collar 30 of low height is provided in the upper part for generating underpressure.

This stem body 24 extends via a protuberance 32 designed to accommodate the stem arm 12 and manufactured with the stem body 24 in such a way as to constitute a monolithic part.

In the lower part, the stem body 24 accommodates a peripheral groove 34 and slots 36, in this case four slots 36, oriented radially for providing general steering.

The stem 10 also comprises a base 38 that comprises a head 40 with attachment means 14 on the fork tube 16 and locking/unlocking means 18.

In this embodiment with a locking by wedge, the head 40 is cylindrical in shape on the outside and solid on the inside, with a through hole 42 that is coaxial with the hole 28 of the body 24 but with a diameter that is smaller than said hole 28. This hole 42 is threaded.

This head-set 40 extends toward the lower part by a locking mast 44, with the through hole 42 extending through this locking mast 44 with an over-bore making it possible to make a bearing.

This locking mast 44 has a beveled end 46.

A screw 48 rests by its head 50 on the over-bore made in the hole 42 and passes through the hole 28 that is referenced above for emptying freely from the beveled end 46.

This screw 48 screws into a threading made in a wedge 52 of which the upper part is also beveled in such a way as to work by sliding on the beveled end 46.

The head 40 has locking/unlocking means 18 that comprise at least one blind housing 54, in this case four housings 54 made in said head.

These blind housings 54 are oriented in an essentially radial manner for general steering but in reality, each blind housing 54 makes an angle β with the strictly radial steering as is readily visible in FIG. 4. Each blind housing 54 accommodates a key 56, a return spring 58 being inserted between each key and the bottom of the blind housing in such a way as to return the key toward the outside of its housing.

Each key 56 is preferably parallelepiped in shape with a large size along the longitudinal axis corresponding to that of the axis of rotation of the steering, and each key 56 comprises two beveled edges 60 on the projecting edges of the housing, also along this same longitudinal axis. Instead of the beveled edges, the key can also have a bulging head; this is purely and strictly equivalent as will be shown during the following description of the operation.

The locking/unlocking means 18 also comprise a maneuvering and actuating ring 62.

This ring 62 moves in rotation around the stem body 24 and rests on a collar 64 made on the periphery of the head 40. This collar 64 also has a stop 66.

The ring 62 that moves in rotation is advantageously slit to allow its mounting, screws ensuring the mechanical tightening, with slight friction after mounting on the lower part of the headset 40, facing the groove. The ring 62 itself has a partially circumferential groove 68, designed to accommodate an elastomeric retaining ring 70 that is suitable for exerting an elastic return force in rotation by forcing it against the stop 66, as will be explained later, when the ring is maneuvered in rotation.

Furthermore, on its inside surface, this ring 62 has projections 72 that are convex in shape and each placed relative to a housing 54 and therefore with a corresponding key 56 when the ring is in neutral locking position. Thus, in the embodiment shown with four housings 54 and four keys 56, the ring has four projections 72.

When the ring 62 is rotated, the inside wall of the ring 62, between the projections, pushes back the keys 56, with this inside wall being mounted with slight friction around the lower part of the headset 40, facing the groove 34.

The keys are therefore flush with the surface of the stem body.

The ring 62 moves in rotation that is adjusted to an arc sector that is limited by the return elastomeric retaining ring 70.

The ring 62 is equipped with a maneuvering lever 74 that can be actuated manually, oriented radially, manufactured with the ring and therefore monolithic. In an advantageous way, the joint plane of the slit ring is placed in the median place of this lever 74, and the mechanical tightening screws are placed at the bottom of the lever that comprises an adequate mass of material.

The entire mounting is completed by a screw 76 whose threaded body 78 can work with the threading of the hole 42 and whose head 80 can rest on the stem body 24 in such a way as to be able to make the stem body 24 integral in translation with the headset 40.

The mounting of the device is now described in a first so-called standard mounting type with a mast and wedge mounting.

First: The mounting of the stem designed to accommodate a set of handlebars according to this invention is accomplished by the following series of stages knowing that, for the industrial and commercial product, this mounting will be carried out in a factory, and the stem will be ready to mount on the frame.

The first stage consists in inserting the keys 56 that are equipped with their springs, in this case the four keys, into their housings, with the springs not being compressed and the keys projecting.

The elastomeric retaining ring 70, preferably designed in an arc, is positioned on the collar 64.

The stem body 24 is inserted into the ring 62 by its lower part, in such a way that the groove 34 and the windows 36 that it has face the inside part of the ring 62, with the projections 72 being in the same horizontal plane as the windows 36.

This premounted unit is inserted into the upper part of the headset 40. During the insertion of the stem body 24 around the head 40, by the top, the keys 56 are totally pushed back into their respective housings by compressing the springs 58.

The mechanical tightening screws of the ring are then tightened, which has the effect of linking the three parts: head 40, ring 62 and stem body 24.

The unit is then installed on the fork tube 16.

The locking mast 44 is inserted through the steering socket of the bicycle frame (not shown) in a known way and penetrates into the fork tube 16 until the collar 64 rests on said socket in general.

The screw 48 is in place and works with the wedge 52.

The user tightens the screw 48, which has the effect of pulling on the wedge 52 which, owing to the arrangement of the two opposite beveled surfaces, moves and becomes off-centered, thus immobilizing said wedge and the mast 44 in the fork tube 16.

Then, it is advisable to tighten the screw 76 in the threaded hole 42 whose head 80 rests on the stem body 24 and that mechanically makes it integral in a definitive way with the head and with the mast. It is noted that the drawing of FIG. 1 shows a finishing and cleanliness cover that prevents the penetration of water and dust.

Then, the user can ensure the mounting of the stem arm 12 and the set of handlebars, with the arm 12 having been able to be left in place from the beginning of the mounting of the stem according to this invention in the fork tube 16.

The user then places the stem according to this invention, mounted on the frame.

As soon as the user actuates in rotation the stem, if this is not already the case, the keys 56, pushed by the springs, will project partially as soon as the windows 36 will be facing the housings 54.

When the set of handlebars is oriented in riding position, the mounting of the ring 62 is provided so that the projections 72 are also facing the keys 56, making it possible to lock the rotation of the stem body 24 relative to the headset 40.

It is noted that the keys move in a straight line that is inclined by an angle β relative to a radius, off center, which leads to an automatic regaining of play because each key moves more or less far in the corresponding projection and there is over-centering.

Riding is therefore highly precise as in the case of an arrangement without locking/unlocking means.

When the user wishes to position his set of handlebars essentially in the plane of the frame of the bicycle, he just has to move in rotation the lever 74 and the ring 62 that is integral with it. The ring 62 rotates relative to the unit of the stem body 24 and headset 40. By its inside track, the ring 62 pushes back the keys 56 into their housings 54 through the slots 36.

The keys are located flush with the outside surface of the headset 24.

With the keys 56 each being provided with a beveled edge 60, it is possible to bring about an additional retraction of each key because the edge of each slot 36 rests on the beveled edge 60 upstream from the direction of rotation, and the rotation of the stem body 24 brings about the movement in translation toward its housing 54 of each key 56, against the elastic return force of their spring 58.

The user is to make a slight effort that makes it possible to create a hard point that is very easily surmountable but that makes it possible to feel the disengagement with a “click” effect.

The stem body 24 is then free relative to the headset 40 that is stationary relative to the frame.

The set of handlebars that is integral with the arm 12 that is itself integral with the stem body 24 can then be oriented essentially within the plane of the frame.

In the arrangement shown, the keys 56 will again be located facing the windows 36, with an offset of 90°, and these keys will ensure again the locking in rotation of the stem body 24 relative to the headset 40 by passing through said windows 36 and by coming into the projections 72 facing each other.

It is also noted that because of the arrangement of the housings 54 whose longitudinal axis does not pass through the central axis, the angle β leads to a cancellation of the play of the keys in said housings and during their passage through the windows 36 because they are placed on the slant.

Riding when the set of handlebars is perpendicular to the plane of the frame is highly precise because of this cancellation of play and therefore becomes very comfortable for the user.

The stem according to this invention can also be mounted on the fork tube with a slit ring 90 that is integrated and a tightening collar 92. In this case, the stem body 24 is unchanged, and the headset 40 has only the integrated ring 90, without a mast and without a wedge.

As a result, the fork tube 16 is inserted into the slit ring, and the collar 92 ensures the tightening of this slit ring although the unit is also made integral in translation and in rotation.

This mounting variant in no way affects the stem in itself and the associated locking/unlocking means and provides another solution for mounting on the fork tube exclusively.

FIGS. 8, 9, 10 and 11 show an ahead-set mounting of the stem according to this invention on a bicycle front fork.

In this arrangement, the references to identical elements or to identical functions are mentioned by adding 100 to each of said references relative to the first set of figures.

The stem arm 112 is fixed on the stem body 140, seen in FIG. 9.

The headset 124 is cylindrical in shape and bears locking/unlocking means 118 as above of the keys 156 placed in the housings 154 and pushed toward the outside of said housings 154 by elastic return springs 158. In a symmetrical way, four keys are also provided in this arrangement.

The housings 154 are also each with a longitudinal axis that does not pass through the off-center, central longitudinal axis.

The keys 156 comprise beveled edges 160 on their longitudinal edges, i.e., vertical edges, or have a rounded profile, as above.

The keys 156 of this embodiment comprise an additional special feature, that of placing a beveled edge 160-1 on the upper part.

A core 152 is fixed in the fork tube and accommodates a screw 148 for ensuring the tightening of the stack of different headset elements 140 and stem body elements 124 as well as rings and other bearings referenced 164 overall. This is the ahead-set mounting.

The head 140 accommodates the stem arm 112 as shown in FIG. 8.

An upper hood 162 moves in vertical translation and accommodates a vertical elastic return element 170, in this case a helical spring.

This hood 162 comprises safety means, in this case two windows 163 through which two push buttons 165 pass, this being only a preferred embodiment, preferably placed diametrically. These two push buttons 165 are connected by a deformable ring 167 that ensures the projection of said push buttons.

Stops 169 that are integral with the push button, shown in diagrams in the figures, prevent maneuvering in vertical translation because of the elastic return force of the deformable ring and allow the vertical translational movement when the push buttons are brought together radially.

The hood 162 is also provided with a peripheral beveled edge that faces keys 156 and more particularly faces beveled edges 160-1 of said keys.

The mounting is therefore as follows.

The fork tube 116 passes through the socket of the frame of the bicycle and is fitted into the stem body 124. The screw 148 is tightened and ensures the immobilization by vertical translation of this unit and the compression for eliminating any vertical play and for making it possible, in a known way, for bearings and rings to perform their roles.

The keys 156 are in place in their housings 154.

The stem arm 112 is connected to the headset 140 prior to the mounting of said head, even if it is not tightened and immobilized in rotation.

The headset 140 is then fitted, and the slots 136 allow the keys 156 to pass once said headset 140 is installed and oriented in a suitable way.

The spring 170 is positioned, and the hood 162 also with its push buttons 165. A screw 176 ensures the engagement of the hood with the stem body 124.

The operation is therefore identical to the variant with a standard mounting with a mast and a wedge, the difference coming from the actuation.

Actually, when the user wishes to put his set of handlebars and therefore his stem in the plane of the frame of the bicycle, he rests on the push buttons 165 against the elastic return forces of the deformable ring 167.

The user can then rest on the hood 162 and move it in vertical translation against the elastic return force of the spring 170.

This translational movement of the hood 162 brings about the retraction of the keys 156 into their housings 154 in the stem body 124 by resting on the upper beveled edges 160-1 of said keys.

The user, by an action on the set of handlebars and therefore on the stem 112, brings about the rotation of the headset 140 and the beveled edges 160 of the keys, or the rounded shapes create a hard point, overtopped with a very weak force owing to the lever arm of the set of handlebars, which constitutes a small maneuvering “click.”

As soon as the user has carried out a rotation of 90°, the keys 156 take their places again through the slots 136 and engage in rotation the headset 140 and the stem body 124, and therefore make the wheel and the set of handlebars integral.

It is possible to benefit from this hood 162 for integrating additional equipment such as electronic accessories.

It is also possible to add a lock for immobilizing the stem in the storage position, which makes riding the bicycle more difficult and which therefore plays the anti-theft role.

In this ahead-set mounting, the disappearance of the operational play is noted again, which makes possible precise riding with a feeling of safety without this disrupting the operation for the user.

In addition, the parts can be made essentially of composite material in such a way as to lighten the components and to impart attractive esthetic shapes.

The stem for a set of bicycle handlebars with controlled release of its steerability according to this invention makes possible the two functions of storage and anti-theft by means of the affixing of a lock while eliminating play.

1. Stem (10) for a set of bicycle handlebars with controlled release of its steerability comprising a body (24, 124) designed to accommodate a stem arm (12, 112) itself accommodating a set of handlebars, with said stem also comprising a headset (40, 140), means (14, 114) for attaching said stem (10) on the fork tube (16, 116) of a bicycle comprising a steering socket and locking/unlocking means (18, 118), characterized in that these locking/unlocking means (18, 118) comprise at least one key (56, 156) placed in a housing (54, 154) made in the headset (40, 140), elastic return means (58, 158) of this at least one key toward the outside of said housing, slots (36, 136) made in the stem body (24, 124) through which pass said keys, a ring (62) or a hood (162) making it possible to retract the at least one key (56, 156) through said slots (36, 136) by a movement respectively of rotation or translation.

2. Stem (10) for a set of bicycle handlebars according to claim 1, wherein the housings (54, 154) are made with an off-center longitudinal axis relative to the longitudinal axis of rotation.

3. Stem (10) for a set of bicycle handlebars according to claim 1, wherein the housings (54, 154) are four in number.

4. Stem (10) for a set of bicycle handlebars according to claim 1, wherein the headset (40) comprises a mast (44) and a wedge (52) with a screw (48) for its attachment in the fork tube (16).

5. Stem (10) for a set of bicycle handlebars according to claim 1, wherein the headset (140) comprises a core (152) with a screw (148) for its attachment in the fork tube (116).

6. Stem (10) for a set of bicycle handlebars according to claim 1, wherein the ring (62) comprises projections (72) designed to accommodate the keys (56) in certain given angular positions.

7. Stem (10) for a set of bicycle handlebars according to claim 1, wherein the ring (62) comprises a partially circumferential groove (68) that is designed to accommodate an elastic return element (70) such as an elastomeric retaining ring.

8. Stem (10) for a set of bicycle handlebars according to claim 1, wherein the ring (62) comprises a maneuvering lever (74), manually actuatable, oriented radially, manufactured with the ring and therefore monolithic.

9. Stem (10) for a set of bicycle handlebars according to claim 1, wherein the hood (162) comprises two windows (163) through which pass two push buttons (165), with these two push buttons (165) being connected by a deformable ring (167) ensuring the projection of said push buttons.

10. Stem (10) for a set of bicycle handlebars according to claim 9, wherein the hood (162) comprises stops (169) that are integral with the push button, preventing maneuvering by vertical translation and allowing the vertical translational movement when the push buttons (165) are brought together radially.

11. Stem (10) for a set of bicycle handlebars according to claim 1, wherein the at least one key (156) comprises an upper beveled edge (160-1), in such a way that during vertical translational movements of the hood (162), the at least one key (156) is retracted into its housing (154) in the stem body 124.

12. Stem (10) for a set of bicycle handlebars according to claim 1, wherein the hood (162) comprises additional equipment such as electronic accessories.

13. Stem (10) for a set of bicycle handlebars according to claim 2, wherein the housings (54, 154) are four in number.

14. Stem (10) for a set of bicycle handlebars according to claim 2 wherein the headset (40) comprises a mast (44) and a wedge (52) with a screw (48) for its attachment in the fork tube (16).

15. Stem (10) for a set of bicycle handlebars according to claim 3, wherein the headset (40) comprises a mast (44) and a wedge (52) with a screw (48) for its attachment in the fork tube (16).

16. Stem (10) for a set of bicycle handlebars according to claim 2, wherein the headset (140) comprises a core (152) with a screw (148) for its attachment in the fork tube (116).

17. Stem (10) for a set of bicycle handlebars according to claim 2, wherein the ring (62) comprises a partially circumferential groove (68) that is designed to accommodate an elastic return element (70) such as an elastomeric retaining ring.
